(19) United States
(12) Patent Application Publication
(10) Pub. No.: US 2003/0100334 A1
(43) Pub. Date: May 29, 2003

(54) Dialing programmed numbers from a mobile communication unit while internationally roaming

(75) Inventor: William E. Mazzara JR., Drayton Plains, MI (US)

Correspondence Address: General Motors Corporation, Legal Staff, Mail Code 482-C23-B21, 300 Renaissance Center, P.O Box 300, Detroit, MI, 48265-3000, US

(73) Assignee: General Motors Corporation

(21) Appl. No.: 10/046,571

(22) Filed: Oct. 26, 2001

(51) Int. Cl. H04M 1/00

(52) U.S. Cl. 455/552; 455/564; 455/433

(57) ABSTRACT

Dialing numbers from a mobile communication unit (MCU) operating in an international roaming mode is accomplished by using the SID code of a base station communicating with the MCU for determining the necessary prefixes to be appended to a number to be. A mobile communication unit initiates communication between the MCU and a base station having an SID code by dialing a number to be called by the MCU, and receiving the SID code at the MCU. Once the MCU has received the SID code, necessary calling prefixes, if any, are determined for placing a call from the MCU to the number to be called via the base station having the received SID code. Any necessary calling prefixes are appended to the number to be called, and a communication link is established between the MCU and the number to be called, via the base station having the SID code. The MCU may utilize a database of dialing prefixes required to dial the number to be called from base stations having SID codes, and determining the necessary calling prefixes by searching the database for the received SID code by searching the database for either or both of the received SID code or a range of SID codes including the received SID code.

### TECHNICAL FIELD OF THE INVENTION

This invention relates to mobile communication units, and more particularly to operation of mobile communication units in an international roaming mode.

### BACKGROUND OF THE INVENTION

Mobile communication units (MCU's), such as cellular phones, personal data assistants (PDA's), Global Positioning System (GPS) devices, and on-board Vehicle Communication Units (VCU's), used in conjunction with a Wide Area Network (WAN), such as a cellular telephone network or a satellite communication system, have made it possible for a person to send and receive voice communications, data transmissions, and FAX messages from virtually anywhere on earth. Such communication is initiated at the MCU when it is turned on, or by entering a phone number to be called, or in many cases, by pressing a preprogrammed button on the MCU or speaking a voice command causing the MCU to automatically complete the process of dialing the number to be called. A radio communication link is established between the MCU and a Wide Area Network (WAN), using a node of the WAN in the vicinity of the MCU.

In cellular telephone systems, a node is commonly referred to as a “cellular base station.” For ease of understanding, the following description and illustrations of my invention will use a WAN in the form of a cellular telephone system, and the node will be represented by a cellular base station. Once the radio communication link between the MCU and the cellular base station has been established, the base station then utilizes a combination of additional cellular stations, conventional telephone wire line networks, and possibly even satellite systems to connect the MCU to the number to be called.

For an MCU operating in a single country of origin, existing communication systems are highly automated and capable of making the complex connections between the MCU and the number to be called in a manner that is, in most cases, virtually imperceptible to the person initiating communication from the MCU. Indeed, MCU users expect and demand that they be able to place a call with little or no effort on their part, beyond dialing a phone number, or pressing a speed dial button.

For MCU's which must operate in more than one country or along the border between two countries, however, existing systems have not been capable of delivering the same level of effortless connection because the connections required to complete the call include one or more international connections. The calling prefixes that must be appended to the basic number to be called are different for international direct dial (IDD) than the prefixes required for national direct dial (NDD) or local calls. International calls typically require that additional prefixes including a country and city code of the number to be called be appended to the basic number, and in some cases also require that some of the prefixes used for national direct dialing be dropped when dialing an international call.

For an MCU operating in an international roaming mode, there are literally thousands of possible prefix requirements which must potentially be dealt with, dependent upon which country the MCU, the cellular and wire line carriers, and the number to be called are located with respect to one another. Dialing formats vary considerably from country to country, making it very difficult to know exactly how the number to be called must be modified when making a call between a particular pair of countries. Prior MCUs and cellular systems have left the burden of dealing with the changes in prefixes required for international dialing with the person making the call.

Adding to the burden on the person using the MCU in an internationally roaming mode, there are special arrangements between some countries which are exceptions to general rules governing the circumstances under which IDD prefixes must replace NDD prefixes. For example, an MCU which can be used in a non-internationally roaming mode to place calls to numbers within the United States, can also place calls to Canada, Puerto Rico, and many Caribbean Countries using NDD prefixes in the same manner used for dialing a number within the United States, rather than IDD prefixes. IDD prefixes will be required, however, if the same MCU is used to place a call to a number in Mexico, or other countries of the world.

The burden of dealing with calling prefixes in international calls is not unique to the use of MCU's. Any person wishing to place an international call from either an MCU or a standard phone must deal with the potential need for appending the necessary prefixes to the number to be called, or replacing NDD prefixes with IDD prefixes. Operating an MCU in an internationally roaming mode imposes an additional level of difficulty to placing an international call, however, due to the manner in which cellular telephone networks operate.

At some point in the process of connecting the MCU to the number to be called, the MCU must establish a radio-telephone link to a cellular base station. The cellular base station will then establish a communication link to the number to be called, using cellular and wire-line networks. Where the MCU connects to a cellular base station in another country, while operating in an internationally roaming mode, a call which would normally not require the entry of additional international dialing prefixes if the MCU were operating in its country of origin, becomes an international call. Somehow the cellular system, or the person using the MCU must recognize that this situation exists, and enter or modify the calling prefixes to complete the call.

In normal operation of an MCU within its country of origin, there is no need for the person using the MCU to be aware of the location of the base station via which their call is being connected. Accordingly, existing cellular systems make no provision for the MCU user to know which base station their call is being routed through. There is therefore no way that the user can determine what prefixes are needed for communication through a particular base station.

Even where the MCU has the ability to know its own location in the world, via a direct link to a GPS system, for instance, the location of the base station must also be ascertained, and then the necessary prefixes, if any, must be determined and appended to the number to be called. A GPS system will not provide this information.

The difficulties involved in dealing with international calling are so burdensome that people traveling abroad often leave their own MCU at home and rent special equipment from services which specialize in providing international mobile communication services. For some users this may provide an acceptable solution. But for owners of MCUs which are mounted in vehicles to provide a variety of on-board services to users while traveling, such as OnStar, from General Motors, the need to rent special equipment for international travel is particularly aggravating and inconvenient.

What is needed, therefore, is the capability to place calls from an MCU operating in an internationally roaming mode without requiring the person placing a call to know the location of the cellular base station, or to memorize and append necessary calling prefixes for international calls to the number the person wishes to call. This need is particularly acute for MCU's mounted on-board in vehicles which are commonly operated while the vehicle is in motion where the additional steps of entering necessary prefixes in an internationally roaming mode, could greatly diminish the ability to use MCU based navigational aides, and cause unreasonable frustration and distraction of the vehicle operator.

### SUMMARY OF THE INVENTION

My invention provides a solution to the problems discussed above through utilization of the System Identifier code (SID), which is assigned to each cellular base station in the world. The SID is broadcast to the MCU as part of initiating a communication link between the MCU and the base station, but is not revealed to the user of the MCU. SID codes are generally unique to each market, but all stations within a given country are generally assigned a SID within a given range of SID numbers. For example, base stations in the United States, Canada, and Mexico are generally assigned SID codes in the ranges of 1 through 15999, 16000 through 16999, and 24000 through 24999, respectively. Once the location of the base station is ascertained from the SID code, it can also be ascertained what necessary calling prefixes are required to place an international call via the base station having that SID to numbers located in that country or other countries, from an MCU in an international roaming mode.

One form of my invention provides a method for operating an MCU in an international roaming mode by determining the necessary prefixes to be appended to a number to be called from the SID of a base station communicating with the MCU.

My invention may be implemented in various automated methods, apparatus, and software forms allowing a person wishing to place a call from an MCU in an internationally roaming mode to conveniently deal with the tens of thousands of potential SID codes, anomalies in assignment of the SID codes, and the many potential combinations of location of the MCU and the base station, together with the many different potential combinations of international dialing prefixes and country codes.

My invention provides the needed capability to place calls from an MCU operating in an internationally roaming mode without requiring the person placing a call to know the location of the cellular base station, or to memorize and append necessary calling prefixes for international calls to the number the person wishes to call, through inclusion in the MCU of a database having a tabulation of numbers to be called from the MCU, together with the calling prefixes which must be appended to each of the numbers in the database when a call is made from the MCU to a number in the database via a cellular base station having a particular System Identification (SID) code. My invention thus allows a call to be made from an MCU operating anywhere on earth to a number which may be in another country without the user having to perform any tasks beyond what they would perform to place a call to that same number while the MCU was operating in a normal, non-international roaming mode.

According to one form of my invention, a method for operating a mobile communication unit includes initiating communication between the mobile communication unit and a base station having an SID code, and receiving the SID code at the mobile communication unit. A number to be called is then dialed or selected from speed dial list. The MCU determines what calling prefixes, if any, are required for placing a call from the mobile communication unit to the number to be called via a base station having the received SID code. Any necessary calling prefixes are appended to the number to be called, and a communication link is established between the mobile communication unit and the number to be called, via the base station having the SID code.

My method may include creating a database of dialing prefixes required to dial the number to be called from base stations having SID codes, and determining the necessary calling prefixes by searching the database for the received SID code. My method may also include creating a database of dialing prefixes required to dial the number to be called from base stations having SID codes, and determining the necessary calling prefixes by searching the database for a range of SID codes including the received SID code.

My invention also includes apparatus and software for carrying out the methods of my invention.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram depicting an exemplary MCU in accordance with my invention;

FIG. 2 is a block diagram depicting an exemplary embodiment of code on a computer readable medium in accordance with my invention; and

FIG. 3 is a flowchart depicting an exemplary method for operating an MCU in internationally roaming mode in accordance with my invention.

### DETAILED DESCRIPTION OF THE PRESENTLY PREFERRED EMBODIMENTS

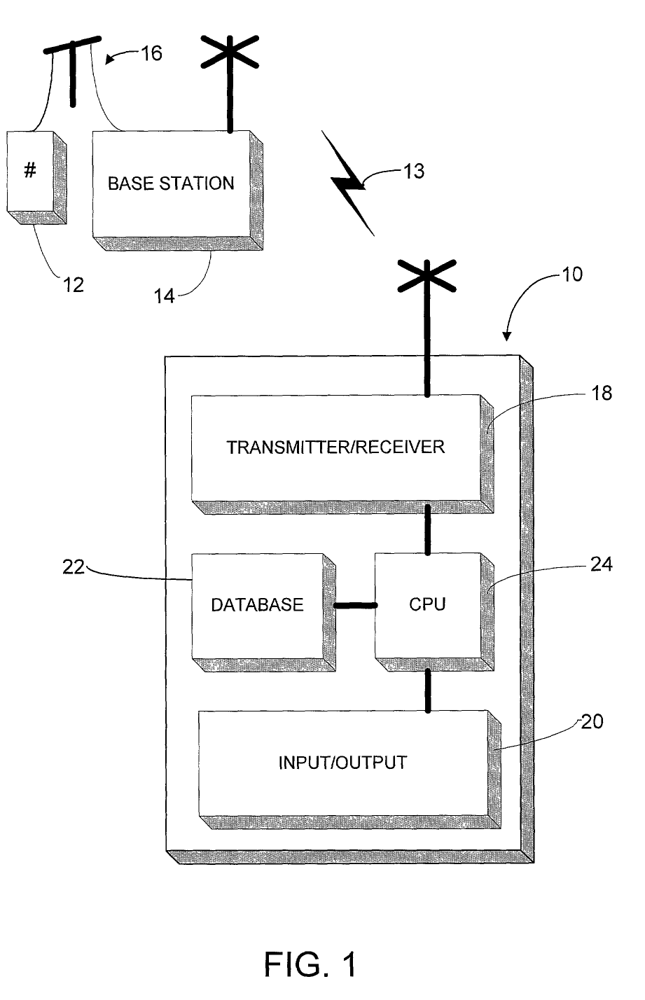

FIG. 1 shows a mobile communication unit (MCU) for an exemplary embodiment of my invention. The MCU 10 communicates with a number to be called 12, via a radio-telephone link 13 with a base station 14 having an SID code, and a wire-line connection 16 between the base station 14 and the number to be called 12.

The MCU 10 includes a transmitter/receiver 18, an input/output device 20, and database 22, connected to a central processing unit (CPU) 24. The input/output device 20 may take many forms known in the art, including an alpha-numeric telephone keypad, a touch screen, speed dial buttons, a data port, an LCD display, or a voice actuated command apparatus.

The database 22 is adapted to store the number to be called 12, together with the SID code of the base station 14, and one or more dialing prefixes required for the MCU 10 to dial the number to be called 12 via the base station 14. It is contemplated that the database 22 may be adapted to receive and store a plurality of numbers to be called, with each number being stored together with a plurality of SID codes representing a plurality of base stations 14 through which the MCU 10 might access each number to be called, and for each of the plurality of SID codes for each number to be called a dialing prefix required for the MCU 10 to dial the number to be called via the base station having that SID code.

The input/output device 20, CPU 24, and transmitter/receiver 18, in combination, provide means for dialing a number stored in the database 22 to be called by the MCU 10, and means for initiating communication between the MCU 10 and the base station 14 having the SID code. The transmitter/receiver 18 and CPU 24, in combination, provide means for receiving the SID code at the MCU 10 from the base station 14.

The CPU 24 includes means for accessing the database and determining the necessary calling prefix for placing a call from the MCU 10 to the number to be called 12, via the base station 14 having the received SID code. The CPU 24 also provides means for modifying the dialed number to form a modified dialed number including the necessary prefixes. The means for accessing the database and determining the necessary calling prefixes may include means for searching the database 22 for either or both of the received SID code, or a range of SID codes including the received SID code.

The combination of the input/output device 20, the CPU 24 and the transmitter/receiver 18 provide means for establishing a communication link between the MCU 10 and the number to be called 12 via the base station 14 having the received SID code, by transmitting the modified dialed number to the base station 14 having the received SID code.

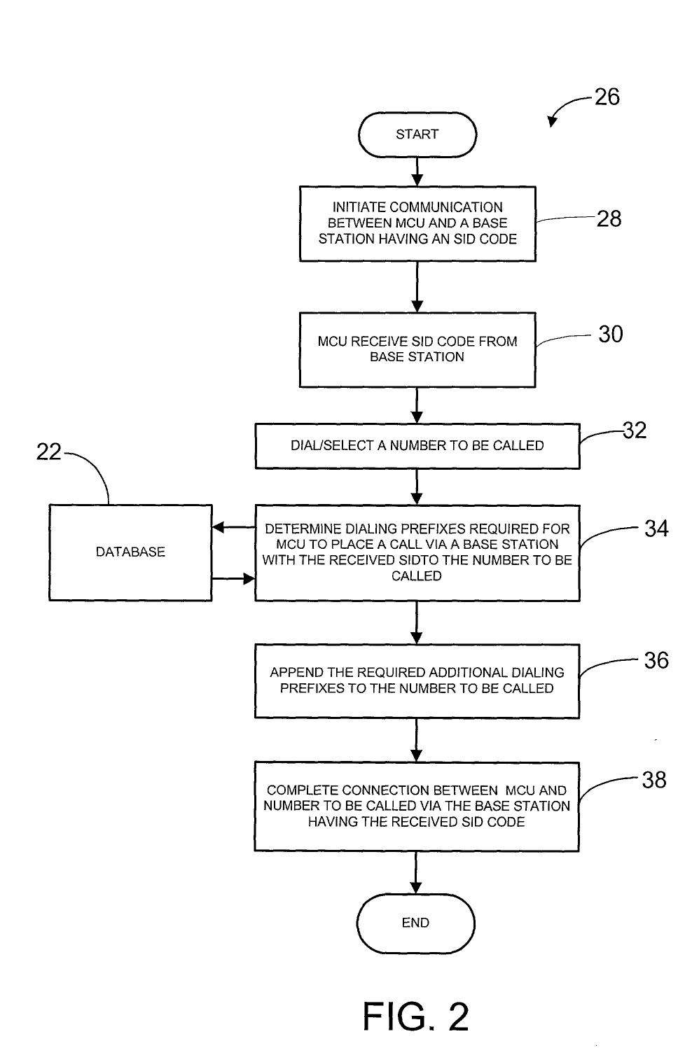

As shown in FIG. 2, my invention may also be implemented in a code 26 on computer readable medium for operating an MCU 10. The code 26 includes instructions for initiating 28 communication between the MCU 10 and a base station 14 having an SID code, and for receiving 30 an SID code from the base station 14. The code 26 also includes instructions for dialing/selecting 32 a number to be called by the mobile communication unit, instructions for determining 34 the necessary calling prefixes required for placing a call from the MCU 10 to the number to be called 12, and instructions for appending 36 the necessary calling prefixes to the number to be called 12. The code 26 further includes instructions for establishing 38 a completed connection between the MCU 10 and the number to be called 12 via the base station 14 having the SID code.

The code 26 may also include a database 22, on computer readable medium, having necessary dialing prefixes required to dial the number to be called 12 via the base station 14 having the SID code, and the instructions for determining 34 the necessary calling prefixes may also include instructions for searching the database 22 for either or both of the received SID code, or a range of SID codes including the received SID code.

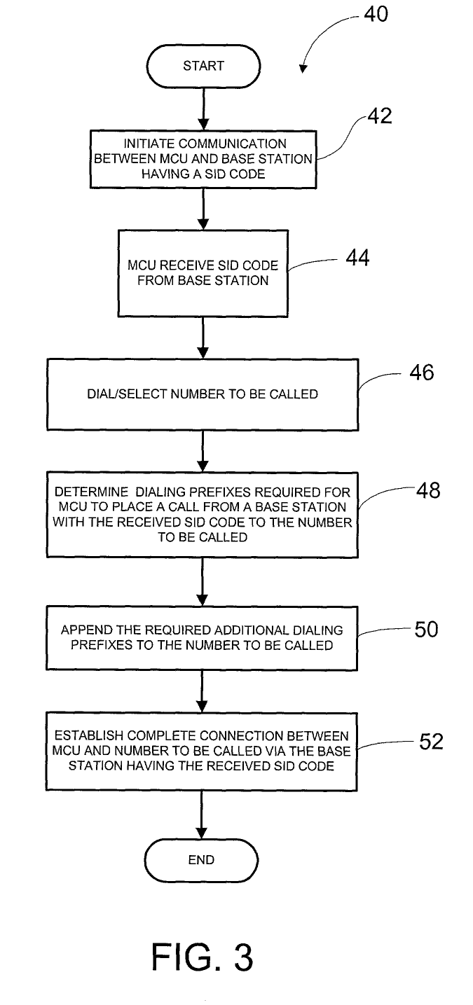

FIG. 3 depicts a method 40 for operating an MCU 10 by initiating 42 communication between a base station 14 having an SID code, and for receiving 44 the SID code from the base station 14. The method 40 further includes instructions for dialing 46 a number to be called 12 by the MCU 10, and determining 48 additional dialing prefixes required for the MCU 10 to place a call to the number to be called 12 via the base station 14 having the received SID code. The method further includes appending 50 the required additional dialing prefixes to the number to be called 12, and establishing a complete connection between the MCU 10 and the number to be called 12 via the base station 14 having the received SID code. The method 40 may also include creating a database 22 of dialing prefixes required to dial the number to be called 12 from the base station having the received SID code, and the step of determining 48 necessary calling prefixes may include searching the database 22 for either or both of the received SID code, or a range of SID codes including the received SID code.

The configuration of the database 22 and the methods of determining the required prefixes will vary considerably, depending on the type and location of the number to be called 12, the country of origin of the MCU 10, the location of the MCU 10 and the base station 14, and the preferences of the user. For purposes of enhancing understanding of my invention, I have provided three examples, designated as Example A, B, and C, of possible embodiments of a database according to my invention.

It should be noted that, although the SID codes and numbers used in Examples A through C are similar in appearance and numerical value to those used in actual cellular systems, the particular values listed in Examples A through C have been arbitrarily selected to enhance understanding of my invention, and are not intended to be limiting. I have also purposely ignored certain anomalies that exist in actual cellular systems, such as the existence of actual base stations in Mexico City which are assigned SID codes of 1525, which is not within the range of SID codes generally used in Mexico, and would normally indicate base station within the range assigned to stations in the United States. Those having skill in the art will readily recognize that my invention provides a convenient method for dealing with such anomalies in an MCU, a method, or in software, according to my invention.

Example A, below, illustrates the construction and contents of a database 22 for an MCU 10 having set up for national direct dial local and long distance service in the United States, and for international roaming in Canada and Mexico.

### EXAMPLE A

### Automated Direct Dialing of Numbers from an Address Book in an MCU Having Local, National Long Distance, and International Long Distance Numbers

| | | CELLULAR | | | |
|---|---|---|---|---|---|
| SPEED DIAL | # TO BE | BASE STATION | | | |
| DESIGNATION | CALLED | SID | LDD PREFIXES | NDD PREFIXES | IDD PREFIXES |
| 1 | 221-1658 | 15560-15570 | 221-1658 | N/A | N/A |
| | ″ | 1-15559 & | N/A | 1-888-221-1658 | N/A |
| | | 15571-15999 | | | |
| | ″ | 16000-16999 | N/A | 1-888-221-1658 | N/A |
| | ″ | 24000-24999 | N/A | N/A | 0-1-00-888-221-1658 |
| 2 | 1-888-221-1658 | 1-15999 | N/A | 1-888-221-1658 | N/A |
| | ″ | 16000-16999 | N/A | 1-888-221-1658 | N/A |
| | ″ | 24000-24999 | N/A | N/A | 0-1-00-888-221-1658 |
| 3 | 0-52-262-958 | 1-15999 | N/A | N/A | 0-52-262-958 |
| | ″ | 16000-16999 | N/A | N/A | 0-52-262-958 |
| | | 24000-24999 | N/A | 01-262-958 | N/A |
| 4 | 262-958 | 24010-24012 | 262-958 | N/A | N/A |
| | ″ | 24000-24009 & | N/A | 01-262-958 | N/A |
| | | 24013-24999 | | | |
| | ″ | 1-15999 | N/A | N/A | 0-52-262-958 |
| | ″ | 16000-16999 | N/A | N/A | 0-52-262-958 |

The first number, designated as Speed Dial #1, is set up to be called as a local number, without NDD prefixes, in the United States via cellular base stations in the local service area of the cellular service provider, having SID codes in the range of 15560 through 15570. Because this is local service, the database shows that no NDD or IDD prefixes need be appended for calls to the base stations having SIDs in the range of 15560-15570.

If Speed Dial #1 is called from within the US, but outside the local service area, the MCU would be connected through a base station having an SID code in the range of 1-15560 or 15571-15999, and the database shows that the number to be called would have to be modified to include the NDD prefix and area code of the number to be called. This same modified number would be required if the MCU is connected via a base station in Canada, having an SID in the range of 16000-16999, because the United States and Canada both require the same NDD prefix arrangement.

If Speed Dial #1 is called via a base station in Mexico, however, the base station will have an SID code in the range of 24000-24999, and the database indicates that the NDD is replaced with an IDD prefix and the country code for the United States.

The second number, designated Speed Dial #2, is set up to be a national long distance call within the United States. The Local Direct Dial (LDD) column is therefore blank, and the NDD and IDD columns indicate the required prefixes for placing calls to base stations located in the US, Canada, and Mexico.

Speed Dial #3 is set up to be an international long distance call to Mexico from the MCU when communicating through base stations having SID codes in the range of 1-15999 in the United States or base stations having SID codes in the range of 16000-16999 in Canada. When the MCU is operating through a base station in Mexico having an SID code in the range of 24000-24999 the IDD prefix is replaced with an NDD prefix for Mexico.

Speed Dial #4 is set up to be a local call when the MCU is connecting through a base station in Mexico within a local service range having a SID code in the range of 24010-24012, and a national long distance call when the MCU is connecting through a base station in Mexico, outside the local service area, having an SID code in the range of 24000-24009 or 24013-24999. For calls in the local area, the LDD prefixes are used, and for calls outside the local service area in Mexico, the NDD prefixes are used. For calls to Speed Dial #4 from the US or Canada, the MCU will connect via a base station having an SID code in the range of 0-15999, and 16000-16999 respectively, and the database shows that the IDD prefixes must be used.

It is contemplated that that the MCU may incorporate means for selecting the least costly number, i.e. LDD versus NDD service for example. It is also understood that the contents of a database according to my invention may vary considerably from the format used in Example A. It may be desirable to store only the prefixes themselves, and have the MCU remove any prefix from the “number to be called” as it is entered into the database separate from an SID code. The means for accessing the database and determining the necessary calling prefixes may include means for searching the database 22 for either or both of the received SID code, or a range of SID codes including the received SID code.

Example A is an illustration of a database that can accept a variety of call types. For some embodiments of my invention, however, it may be desired to use only one type of number, perhaps a series of national toll free long distance numbers within the country of origin. A more compact database, as illustrated in Example B below, may be used in such embodiments.

### EXAMPLE B

### Automated Direct Dialing of Numbers from an Address Book in an MCU Having Only National Long Distance Numbers

| | | CELLULAR | | |
|---|---|---|---|---|
| SPEED DIAL | # TO BE | BASE STATION | | |
| DESIGNATION | CALLED | SID | NDD PREFIXES | IDD PREFIXES |
| 1 | 1-888-221-1658 | 1-15999 | 1-888-221-1658 | N/A |
| | ″ | 16000-16999 | 1-888-221-1658 | N/A |
| | ″ | 24000-24999 | N/A | 0-1-00-888-221-1658 |
| 2 | 1-888-221-1659 | 1-15999 | 1-888-221-1659 | N/A |
| | ″ | 16000-16999 | 1-888-221-1659 | N/A |
| | ″ | 24000-24999 | N/A | 0-1-00-888-221-1659 |
| 3 | 1-888-221-1660 | 1-15999 | 1-888-221-1660 | N/A |
| | ″ | 16000-16999 | 1-888-221-1660 | N/A |
| | ″ | 24000-24999 | N/A | 0-1-00-888-221-1660 |

The database of Example B is set up to include only three, toll-free long distance numbers, accessible with NDD prefixes when the MCU is connected via a base station in the United States and Canada, and accessible with IDD prefixes when the MCU is connected via a base station in Mexico. There are no local number alternatives in any country in the table.

### EXAMPLE C

### Automated Direct Dialing Access to Services Using a Listing of Local Numbers for Various SID Codes from a Database in an MCU

| | | LDD |
|---|---|---|
| SERVICE DESIGNATION | SID | NUMBER |
| RED BUTTON - EMERGENCY | 1-15999 | 221-1658 |
| ASSISTANCE | 16000-16999 | 695-4021 |
| | 24000-24999 | 262-958 |
| BLUE BUTTON - INFORMATION | 1-15999 | 221-1659 |
| | 16000-16999 | 695-4022 |
| | 24000-24999 | 262-959 |
| WHITE BUTTON - COMMUNICATION | 1-15999 | 302-2345 |
| | 16000-16999 | 562-1111 |
| | 24000-24999 | 232-596 |

In Example C, the MCU has three push buttons for three types of services respectively that may be desired by the user. The database has a listing of local numbers for accessing each type of service through a node of a wide area network having a particular SID code. For simplicity of illustration, only one local number has been illustrated for a range of SID codes, but in practice the database may include a large number of SID codes, each linked to a particular local access number.

Specifically, Example C illustrates the manner in which a user may access a local number for a desired service through stations having SID codes allocated to markets in the United States, Canada, or Mexico by simply pressing a colored button. A user needing to access emergency services, for example, would simply press the red button of the MCU. The MCU would select the appropriate local number from the database for the SID code of the station through which communication would be established, and complete the connection.

Stated another way, all the user has to do is to indicate what service is needed or desired, and regardless of what country the user is in at that time, the MCU will select a local access number from the database and complete the connection with that local number. The user need not be concerned about how to access the desired service in each country, or be distracted from driving or dealing with an emergency, because the MCU does all the work of figuring out how to make the connection to a local number in that country.

From the foregoing description, it has been shown that my invention provides the needed capability to place calls from an MCU operating in an internationally roaming mode without requiring the person placing a call to know the location of the cellular base station, or to memorize and append necessary calling prefixes for international calls to the number the person wishes to call. My invention thus allows a call to be made from an MCU operating anywhere on earth to a number which may be in another country without the user having to perform any tasks beyond what they would perform to place a call to that same number while the MCU was operating in a normal, non-international roaming mode.

Although the forgoing description has utilized certain exemplary embodiments of my invention, various changes and modifications can be made without departing from the spirit and scope of the invention. The scope of the invention is indicated in the appended claims, and all changes that come within the meaning and range of equivalents are intended to be embraced therein.

I claim:

1. A method for operating a mobile communication unit, the method comprising:
initiating communication between the mobile communication unit and a base station having an SID code;
receiving the SID code at the mobile communication unit;
dialing a number to be called by the mobile communication unit;
determining necessary calling prefixes for placing a call from the mobile communication unit to the number to be called via a base station having the received SID code;
appending necessary calling prefixes to the number to be called; and
establishing a communication link between the mobile communication unit and the number to be called via the base station having the SID code.

2. The method of claim 1 further comprising:
creating a database of dialing prefixes required to dial the number to be called from base stations having SID codes; and
wherein the step of determining necessary calling prefixes for placing a call from the mobile communication unit to the number to be called via a base station having the received SID code includes searching the database for the received SID.

3. The method of claim 1 further comprising:
creating a database of dialing prefixes required to dial the number to be called from base stations having SID codes; and
wherein the step of determining necessary calling prefixes for placing a call from the mobile communication unit to the number to be called via a base station having the received SID code includes searching the database for a range of SID codes including the received SID code.

4. The method of claim 1 further comprising:
creating a database of necessary dialing prefixes required to dial the number to be called from base stations having SID codes; and
wherein the step of determining necessary calling prefixes for placing a call from the mobile communication unit to the number to be called via a base station having the received SID code includes searching the database for the received SID, and if the received SID is not in the database, searching for a range of SID codes encompassing the received SID code.

5. A mobile communication unit for communicating with a number to be called from the mobile communication unit via one of a plurality of base stations each having an SID code, the mobile communication unit comprising:
a database for storing the number to be called by the mobile communication unit, together with the SID code of each of the plurality of base stations via which the mobile communication unit may access the number to be called, and for each SID code in the database a dialing prefix required for the mobile communication unit to dial the number to be called via the base station having that SID code;
means for dialing the number stored in the database to be called by the mobile communication unit;
means for initiating communication between the mobile communication unit and the base station having the SID code;
means for receiving the SID code at the mobile communication unit from the base station having the SID code;
means for accessing the database and determining the necessary calling prefix for placing a call from the mobile communication unit to the number to be called via a base station having the received SID code;
means for modifying the dialed number to form a modified dialed number including the necessary calling prefixes; and
means for establishing a communication link between the mobile communication unit and the number to be called via the base station having the received SID code by transmitting the modified dialed number to the base station having the received SID code.

6. The mobile communication unit of claim 5 wherein the means for determining necessary calling prefixes for placing a call from the mobile communication unit to the number to be called via a base station having the received SID code includes means for searching the database for the received SID code.

7. The mobile communication unit of claim 5 wherein the means for determining necessary calling prefixes for placing a call from the mobile communication unit to the number to be called via a base station having the received SID code includes means for searching the database for a range of SID codes including the received SID code.

8. The mobile communication unit of claim 5 wherein the means for determining necessary calling prefixes for placing a call from the mobile communication unit to the number to be called via a base station having the received SID code includes means for searching the database for the received SID code.

9. The mobile communication unit of claim 8 wherein the means for searching the database further includes means for searching the database for a range of SID codes including the received SID code.

10. A computer usable medium for operating a mobile communication unit, comprising:
computer readable code for initiating communication between the mobile communication unit and a base station having an SID code;
computer readable code instructions for receiving the SID code at the mobile communication unit;
computer readable code for dialing a number to be called by the mobile communication unit;
computer readable code for determining necessary calling prefixes required for placing a call from the mobile communication unit to the number to be called via a base station having the received SID code;
computer readable code for appending necessary calling prefixes to the number to be called; and
computer readable code for establishing a communication link via the base station having the SID code between the mobile communication unit and the number to be called with necessary calling prefixes appended.

11. The computer usable medium of claim 10 further comprising:
a database having necessary dialing prefixes required to dial the number to be called via base stations having SID codes; and
wherein the computer readable code for determining necessary calling prefixes required for placing a call via a base station having the received SID code from the mobile communication unit to the number to be called includes computer readable code for searching the database for the received SID code.

12. The computer usable medium of claim 10 further comprising:
a database on computer readable medium having necessary dialing prefixes required to dial the number to be called from base stations having SID codes; and
wherein the computer readable code for determining calling prefixes necessary for placing a call from the mobile communication unit to the number to be called via a base station having the received SID code includes computer readable code for searching the database for a range of SID codes including the received SID.

13. The computer usable medium of claim 10 further comprising
a database on computer readable medium having necessary dialing prefixes required to dial the number to be called from base stations having SID codes; and
wherein the computer readable code for determining necessary calling prefixes required for placing a call from the mobile communication unit to the number to be called via a base station having the received SID code includes computer readable code for searching the database for the received SID code.

14. The computer usable medium of claim 13 wherein the computer readable code for searching the database further includes computer readable code for searching the database for a range of SID codes including the received SID code.

15. A method for operating a mobile communication unit (MCU), the method comprising:
creating a database of access numbers to be called from base stations having SID codes for accessing a desired service via a received SID code;
initiating communication between the mobile communication unit and a base station having an SID code in the database;
receiving the SID code at the mobile communication unit;
requesting that the MCU access the desired service;
determining the access number in the database for accessing the desired service via the base station having the received SID code; and
establishing a communication link between the mobile communication unit and the determined access number in the database for accessing the desired service via the base station having the SID code.

16. A mobile communication unit comprising:
means for creating a database of access numbers to be called from base stations having SID codes for accessing a desired service via a received SID code;
means for initiating communication between the mobile communication unit and a base station having an SID code in the database;
means for receiving the SID code at the mobile communication unit;
means for requesting that the MCU access the desired service;
means for determining the access number in the database for accessing the desired service via the base station having the received SID code; and
means for establishing a communication link between the mobile communication unit and the determined access number in the database for accessing the desired service via the base station having the SID code.

17. A computer usable medium for operating a mobile communication unit, comprising:
computer readable code for creating a database of access numbers to be called from base stations having SID codes for accessing a desired service via a received SID code;
computer readable code for initiating communication between the mobile communication unit and a base station having an SID code in the database;
computer readable code for receiving the SID code at the mobile communication unit;
computer readable code for requesting that the MCU access the desired service;
computer readable code for determining the access number in the database for accessing the desired service via the base station having the received SID code; and
computer readable code for establishing a communication link between the mobile communication unit and the determined access number in the database for accessing the desired service via the base station having the SID code.
